(19) United States
(12) Patent Application Publication
(10) Pub. No.: US 2013/0231998 A1
(43) Pub. Date: Sep. 5, 2013

(54) SYSTEM AND METHOD FOR ADVERTISING UTILIZING GIVEAWAYS

(71) Applicant: Michael Bell, Pt. St. Lucie, FL (US)

(72) Inventor: Michael Bell, Pt. St. Lucie, FL (US)

(21) Appl. No.: 13/885,125

(22) PCT Filed: Mar. 3, 2012
(86) PCT No.: PCT/US12/27634

§ 371 Date: May 13, 2013

Related U.S. Application Data
(60) Provisional application No. 61/449,022, filed on Mar. 3, 2011.

(51) Int. Cl. G06Q 30/02

(52) U.S. Cl. CPC G06Q 30/0236
USPC 705/14.36

(57) ABSTRACT

The invention is a novel, effective, and affordable way of advertising (the “System”, or the “Invention”) through the use, at least in part, of periodic giveaways offered by Businesses to Consumers. The Invention provides a system and means for enabling a business entity (“Business”) to promote its name, products, special offers, and other information relative to the business to the consumers who utilize the invention (“Consumer”). Both the Businesses and the Consumers who utilize the invention must provide certain information about themselves (“Register”). The information provided by the Businesses and Consumers who Register is stored in a Business Information Data Base (BIDB) and Consumer Information Data Base (CIDB) respectively. The information stored in the databases of the System is then usable to perform data mining and analysis to determine specific metrics advantageous to the Business, the Consumer, the Service Provider, or other entities or persons.

### CROSS REFERENCE TO RELATED APPLICATIONS

This patent application is an international application pursuant to PCT Article 11(1)(iii)(a), claiming the benefit of U.S. provisional patent application Ser. No. 61/449,022 which was filed in the United States Patent and Trademark Office on Mar. 3, 2011 and which is incorporated by reference herein in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### TECHNICAL FIELD

The present invention generally relates to the field of Business to Consumer advertising and marketing; however the System of the Invention can be utilized for Business to Business and other marketing as well. The features and elements of the System do not limit its use to Business to Consumer marketing.

### BACKGROUND ART

Businesses have long advertised their goods and services using discounts, coupons and the like. These offerings are typically “one-way” in that the Business does not collect information about the Consumer. However, in recent years it has become desirable that Business collect such information so that they may be able to identify qualified leads, consumers who are ready to purchase, and other targeted potential customers. Systems for such purposes such as Groupon® and the system described in U.S. Patent Publication No. 2010/0287103 disclose a system for group-based coupon bidding, which system is useful for collecting consumer information by offering a coupon to a group of consumers if a minimum number of sales will result, described therein as the “tipping point”. Still other systems such as the system found at www.coupons.com, www.eversave.com and the like exist for the purpose of presenting coupons to consumers. However, while such systems are useful for presentation of discounts or coupons to consumers, they do not provide the opportunity for consumers to win free Giveaways from Business who are users of the system.

### DISCLOSURE OF THE INVENTION

The System of the present invention is directed to advertising products, services, and other features of Businesses who desire to promote such products, services, and features to Consumers by offering to opportunity to win free Giveaways in exchange for Consumer registration with the System. The Invention provides a novel way of promoting such products, services, and other features to consumers who have demonstrated an interest in the offerings of the Business, thereby providing a uniquely targeted channel for Business to Consumer communication.

The invention is a novel, effective, and affordable system for advertising through the use, at least in part, of Giveaways offered by Businesses to Consumers. The Invention provides a system and means for enabling a Business to promote its name, brand, services, products, special offers, and other information relative to the business to persons or other businesses who may be interested in purchasing or utilizing the goods or services offered by the Business. Both the Businesses and the Consumers who utilize the invention must provide certain information about themselves (“Register”) in order to use the system. The information provided by the Businesses and Consumers who register is stored in a Business Information Data Base (BIDB) and Consumer Information Data Base (CIDB), respectively. These databases may be captured in any form known in the art for data storage, and need not be contiguously stored; in other words, they may be distributed in across hardware or virtual platforms as is known in the art.

In a preferred embodiment of the System, the Invention provides a means for enabling the Businesses to select certain products, which may be goods or services, to be offered as promotions (“Giveaways”) at no cost to the Consumer. However, alternate embodiments may charge a fee for participation by Consumers, by Businesses, or both. The Invention provides a means for enabling Consumers to register for each Giveaway they desire to win. On a periodic basis (“Selection Period”) a winner of registered Consumers is selected for each Giveaway. A business may offer one or more Giveaways. For each winning Consumer, a unique indicia (“Identifying Indicia”) is generated that identifies the Consumer, the Business, the period of the winning, and the Giveaway that the Consumer has won. Other information may also be identified by the Identifying Indicia. The Businesses are provided the identifying indicia for each Consumer who has been selected to win a Giveaway posted by that Business, and each winning Consumer is also notified of their win and the identifying indicia for each of the Giveaways they have won. The winning Consumers may then collect their Giveaway by presenting their identifying indicia to the Business in any manner the Business may choose. The Business may apply certain restrictions for collection of the Giveaway.

The system and method of the invention may be controlled and managed by a Service Provider who manages and controls the various means of the system such as:
a. Business registration. Business registration (also called Business Signup) is the process by which a Business registers in the System by providing one or more of the following: contact information such as telephone, email address, and/or physical address; username; password; first name and last name. The business information is stored in the BIDB. The Business may then affirmatively elect to Register with the System. Once registered, the Business is able to participate in the features of the System.
b. Consumer registration. Consumers register (also called Joining) with the System by providing one or more of the following: first name; last name; address; city; state; postal code; email address; phone number; username and password; and may also include a selection for the Consumer to receive special offers and information from Businesses. The Consumer registration may also require Consumers to agree to terms and conditions of use of the System.
c. Collection of Business and Consumer information and storage of Business and Consumer information in data bases. The information provided by participating Businesses is collected and stored in the Business Information Data Base, which may be a consolidated data base or a distributed data base. The information provided by participating Consumers is collected and stored in the Consumer Information Data Base, which may be a consolidated data base or a distributed data base. The following information may also be collected by analyzing consumer use of the system:
   i. Consumer shopping habits and trends.
   ii. Frequency of Consumer use.
   iii. Statistics regarding the popularity of certain Giveaways; product offerings; Consumer participation habits as a function of time of day, day of the week, month of the year, holiday period, or other time metric; Consumer geographic search data; Consumer demographic data; and other information typically desirable for Businesses to use analytically in constructing product offerings that are attractive to their respective market(s).
   iv. The Indicating Indicia for each winner.

Determination of the winners. Determination of the winners by choosing a winner for each Giveaway. The choice may be random or any other method, such as a weighted random choice based upon a metric or plurality of metrics. In a preferred embodiment, winners are chosen on a periodic basis such as once a week, where the period may be selected to optimize the attractiveness of the system to Consumers.

Generation of Indicating Indicia. Generation of Indicating Indicia which specifically identifies the winning Consumer for each Giveaway for each period.

Notification to Businesses and Consumers concerning identity of winners. Notification of the identity of the winning Consumer and the Indicating Indicia to each winning Consumer and to each Business who has offered a Giveaway for which a winner has been chosen. The Consumer then presents the notification, which may include the Indicating Indicia, to the Business for collection of the Giveaway. The Business or the System may impose time limitations on the time period within which the Giveaway must be collected.

Advertising. Advertising the System through various media, for example and not as a limitation, radio, newspaper, print ads, television, internet, social media, and other advertising modes, venues, and methods that are well known in the advertising art, to gain market recognition and increase Consumer and/or Business usage of the System. Advertising the system increases public awareness, and therefore will generally result in increased use of the system, which will in turn increase awareness through personal referrals by users of the system, and so on.

Business Self-Management of Offerings. Providing a method for Businesses to self-update their offerings and information which is presented to Consumers, including for example, and not as a limitation: branding information; contact information; product offerings; service offerings; general information about the Business; prices; specials; discounts; printable coupons and Giveaways.

Coupons. Providing a means for Business to develop printable coupons for Consumer use. Business may enter into the system coupon information which are printable by Consumers who have registered with the system. In this manner business may provide additional value to registered Consumers. The coupons may include any offering the business wishes to offer to registered consumers.

Search by Zip Code. Providing a means for Consumers to search Giveaway offerings by Zip Code, and by distance (“Range”) from a Zip Code (as an example, offerings from Businesses within YY miles of Zip Code XXXXX). Furthermore, in the case wherein there are multiple Giveaways currently pending in the system, the businesses who have entered Giveaways may be listed in order of the retail value of the giveaway or promotion, preferably, but not as a limitation, from highest value to lowest value. In an alternate embodiment this listing may also be reversed so that the businesses may be listed in order from lowest value to highest value. In still further embodiments the businesses may be listed by business name, by geographic location, or by any other metric applicable to businesses. This same preferred and alternate embodiment for ordering Giveaways may be utilized to display upcoming Giveaways that have been entered into the system in advance by business which may be termed, for example, “Next Week's Giveaways”.

Banner and other advertising. The invention also provides for banner advertising on one or more of the web pages of the invention. As an example and not as a limitation, in the embodiment where the system is implemented as a web-based software application, the home page of the invention may provide for the advertising of a particular business by use of at least one banner, or by displaying information about the Business' product offerings. Such advertisements may contain a link to an external site designated by the Business, or to the Business' web page within the invention. Such advertising banners may be included on any web page of the invention, and the System Provider may charge Businesses for the display of such advertising banners.

### BRIEF DESCRIPTION OF THE DRAWINGS

A better understanding of the present invention will be realized from the detailed description that follows, taken in conjunction with the accompanying drawings, in which:

FIG. 1 depicts a flow chart of the steps of a preferred embodiment of the invention.

FIG. 2 depicts an overall block diagram of the relationships of the Invention.

FIG. 3 depicts a flow chart of the steps of business interaction with features of the system.

FIG. 4 depicts a flow chart of the steps of a business creating a giveaway and entering it into the system.

FIG. 5 depicts a flow chart of administrator management of the system.

### DETAILED DESCRIPTION OF THE INVENTION

Although the following detailed description contains many specifics for the purposes of illustration, a person of ordinary skill in the art will appreciate that many variations and alterations to the following details are within the scope of the invention. Accordingly, the following preferred embodiments of the invention are set forth without any loss of generality to, and without imposing limitations upon, the claimed invention.

While the above description contains much specificity, these should not be construed as limitations on the scope of any embodiment, but as exemplifications of the presently preferred embodiments thereof. Many other ramifications and variations are possible within the teachings of the various embodiments.

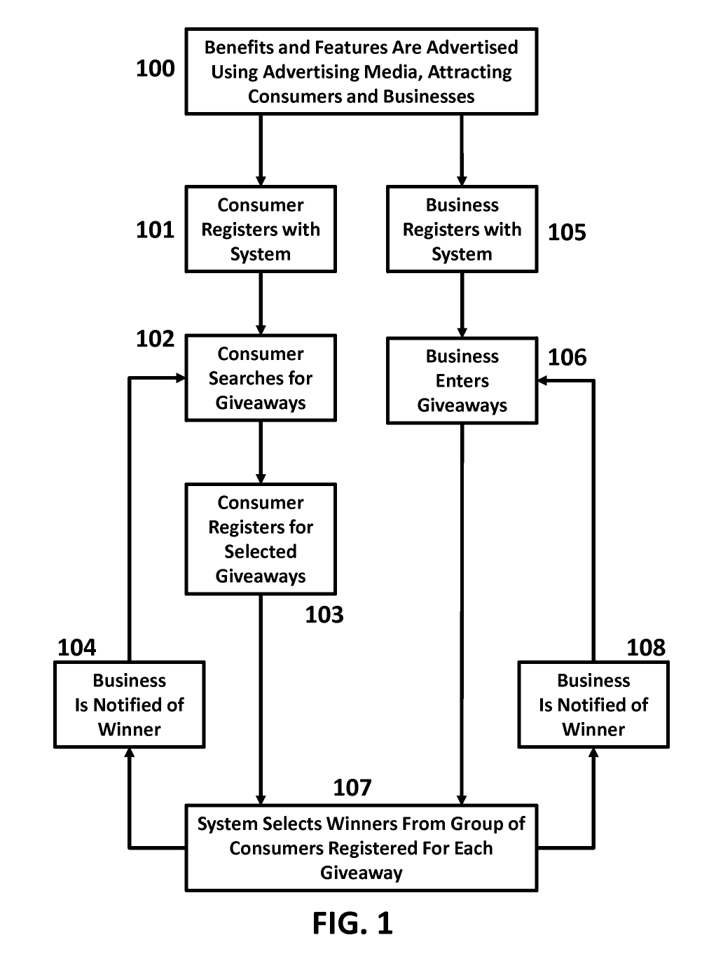

Referring now to FIG. 1, it can be seen that the System of the Invention 1 is accessed by Business 7, Consumers 8, and the Service Provider 5. It is immediately obvious that the system may be implemented in a manual (e.g. paper) system in which the functions of the System discussed herein are performed manually. A preferred embodiment of the system, however, and one that lends itself to extension of the system worldwide, is an embodiment which is internet-based (i.e., web-based) and which uses a series of web pages made available via the world wide web and which use standard techniques for electronic data collection, storage, and transmission (such as email, text, instant messaging, social media, and the like). This preferred embodiment, which is the best mode for carrying out the invention, is discussed in more detail below.

Still referring to FIG. 1, the Service Provider 5 advertises the System in any or all of a number of advertising media which may include, for example and not by way of limitation, print media such as newspapers, magazines, and the like; billboards; television advertisements; radio advertisements; internet advertisements such as banner advertisements, pay-per-click advertisements, and the like; social media advertising campaigns; and other well-known or unique methods for generating market recognition of the System. The purpose of advertising the System is to increase Consumer awareness and participation, thereby making the System a desirable tool for Businesses, which in turn increases Business participation and leads to increased Consumer participation, and so on.

After registering with the System, a Consumer may use the features and elements of the System to search for Giveaways and other offerings from Businesses who are participants in the System. When the Consumer has found a Giveaway for which they wish to register to win, they must register for the Giveaway by providing identifying information about themselves and informing the System that they wish to enter the Giveaway for that period. It is a feature of the preferred embodiment of the System that the Consumer must register for each Giveaway they wish to win.

While some embodiments of the Invention may charge a fee for Consumer participation, a preferred embodiment of the Inventions does not require Consumers to pay to participate in the system.

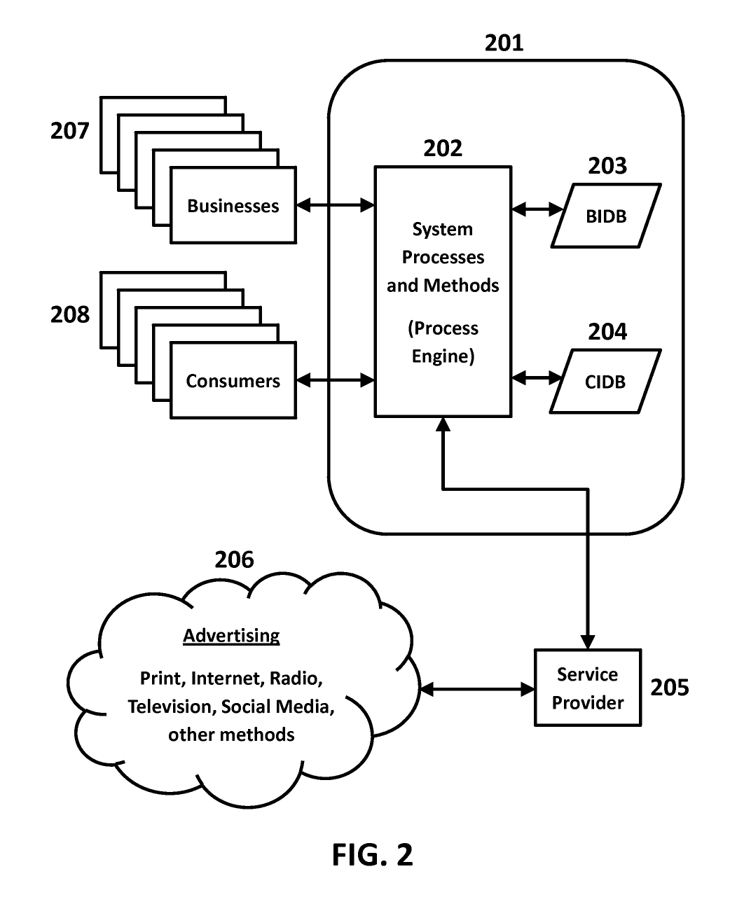

Referring now to FIG. 2, an overall diagram of the System's 201 interaction with Businesses 207, Consumers 208, and the Service Provider 205 is shown. Information provided by Businesses (such as, for example, contact information, product offerings, history of the Business, advantages of utilizing the Business, and the like) to the System is stored in the BIDB 203. Information provided by Consumers to the System is stored in the CIDB 204. The Service Provider 205 utilizes advertising media such as internet advertising, television, radio, print, social media, word-of-mouth and referrals, and other advertising media to promote the attributes and advantages of the system 206. As community awareness of the System grows, Consumers and Businesses begin to register with, and to utilize the features of, the System through the processes and functions of the System 202.

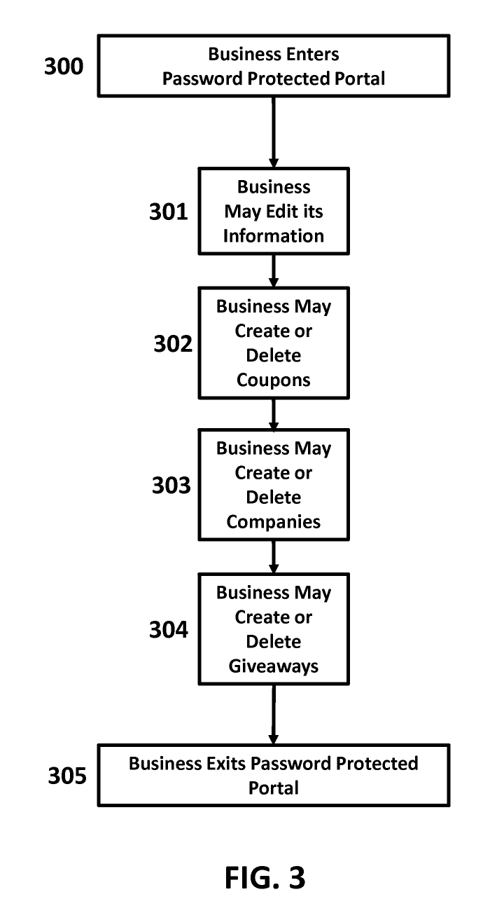

Referring now to FIG. 3, a Business who has registered with the System accesses its information by entering username and password information into the System 300. Upon access to its information, the business may perform any of the following functions: edit its own information such as contact information 301, create or delete coupons 302, create or delete companies or subordinate businesses 303, or create, edit or delete Giveaways 304. Upon completion of editing or reviewing, the Business may leave the password protected portal 305.

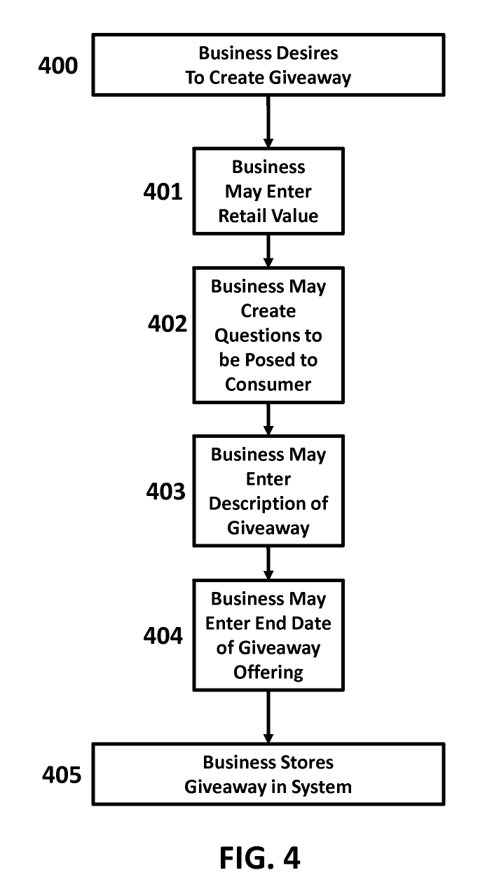

Referring now to FIG. 4, a Business who has registered with the System and who desires to create a Giveaway 400 enters the following information: retail value of the Giveaway 401; questions to be posed to Consumers who Register for the Giveaway 402; Description of the Giveaway 403; and beginning and end date of the Giveaway 404. The Business may then elect to have the System store the Giveaway information 405.

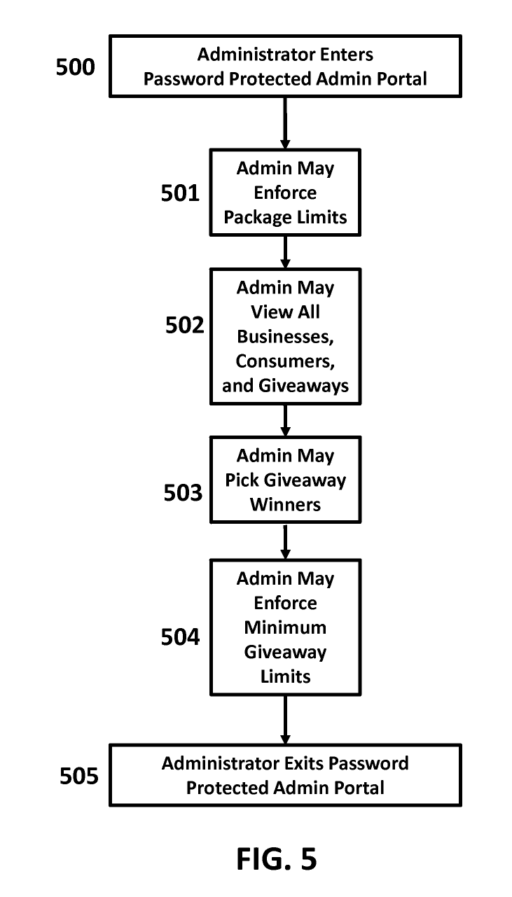

Referring now to FIG. 5, an administrator of the System, who may be, but is not necessarily, a member of the System Provider, enters a password protected administrator portal 500. Upon entry to the administrator portal, the administrator may enforce limits on the Businesses 501 such as maximum number of Giveaways, retail value of Giveaways, or any other limits the System Provider may desire to impose. The administrator may view all Businesses who are users of the System, may view all Consumers who are users of the System, and may view all Giveaways that have been entered into the System 502. The administrator may select Giveaway Winners through any method chosen by the System Provider, which may be, but not necessarily is, a random selection 503. The administrator may also enforce Giveaway minimum Giveaway limits 504. In a preferred embodiment of the System, each Business may be required to enter into the System a minimum number or retail value of Giveaways on a periodic basis, for instance, monthly. If a Business does not enter the minimum number or retail value of Giveaways, they may be warned that they must meet the minimum, or they may be removed from using the System. In this manner the System Provider may ensure that all Businesses that are registered with the System are contributing a minimum number or retail value of Giveaways to the System.

### BEST MODE FOR CARRYING OUT THE INVENTION

An example of the best mode of carrying out the invention, an internet accessible web-based System, is described below. While the particular web links and web pages are described in particular, it is clear to one skilled in the art that the functions described may be instantiated across any number or style of web pages, with the functionality partitioned as the implementer sees fit: the instantiation described is therefore exemplary in nature only. Also, the example embodiment described is for a weekly giveaway period, but it is clear from the description herein that any giveaway period (daily, weekly, monthly, or any other period, or even no period at all) may be utilized by the System.

Businesses and Consumers may enter the System through a Home Page. Referring now to FIG. 2, it is seen that both Businesses and Consumers may become aware of the system through advertising by the Service Provider in various media 206. As awareness of the system increases, Businesses and Consumers enter through a web home page which may display the benefits of the system and allow for registration by both businesses and consumers.

The Home Page may include hyperlinks to other pages of the System. The links may be named with any name or label of the implementer's choosing; the names of the hyperlinks are not a limitation of the invention. From the Home Page, the various processes of the System are accessed and utilized by way of said hyperlinks (“links”) to associated pages. Any page of the System may include a requirement that the Business agree to Terms and Conditions of use of the System. These links may include any part or all of the following links:
Invitation to Join the System, or to Create an Account with the System;
Navigation to a Consumer or Business Account Page or Home Page;
Search for Giveaways;
Search for Businesses;
Business and Consumer Login;
About Us;
Contact;

A preferred embodiment of the System of the Invention provides at least all the above links on each web page of the System to make it easy for the user of the System to quickly access the features of the System described herein.

Each of the linked web pages making up this preferred (but not limiting) embodiment may include links to each of the linked pages from the System Home Page discussed above. While this is not a limitation of the Invention, the preferred embodiment includes these elements for easy navigation of the system.

Before registering with the system, a Consumer may search the system for Giveaways. However, the Consumer may not actually register for Giveaways unless that Consumer is registered with the system. In this manner, the system collects information about each Consumer who wishes to register for a Giveaway.

Referring now to FIG. 1, a Consumer may register with the system by providing certain Consumer information to the system 101. Such consumer information may be any information required by the System Provider, and may include any of the following, which are shown here by way of example and not by way of limitation: username, password, email address, physical address, phone number, facsimile number, age, gender, household income, and the like.

Upon registration, a Consumer may search the system for Giveaways that have been entered into the system by businesses who have registered 102. Giveaway searching may be performed by searching for business location, by searching by business type or by searching for business name. When searching by business location, the Consumer may enter in a postal code, and also may alternatively enter in a radius centered upon a postal code within which the system will return a list of businesses or Giveaways offered by businesses. Alternatively, a map may be provided, upon which the Consumer may click, for example, using a pointing device such as a computer mouse, to select a geographic region in which to search. Such geographic regions may be any region defined by the System Provider, for example, country, state, county, or city boundaries.

After searching for Giveaways, the Consumer may elect to register for selected Giveaways which are of interest 103. Registration for Giveaways is accomplished by the Consumer providing giveaway registration information to the system, which information is passed to the Business that has offered that specific Giveaway. In this manner, Businesses my collect information and metrics regarding those who have expressed interest in their products, which information may prove valuable for that Business' understanding of their potential market, aid in identifying new business, aid in developing targeted demographic advertising campaigns, and the like. Businesses enter into the system a description of the information they wish to collect by providing this information to the system, which function is described further herein.

In this manner, a plurality of Consumers may register for any particular Giveaway.

At a time and date chosen by either the System Provider or, alternatively, by the Business who has entered a Giveaway, at least one Winner is selected from the group of Consumers who have registered for that particular Giveaway 107. In the preferred embodiment of the system, the System Provider selects Giveaway Winners using a random selection method, but in alternate embodiments, any method for choosing Winners may be utilized by the System Provider. In still further alternate embodiments, the Businesses may select the Winners using any method chosen by the Business.

Upon selection of a Winner for a Giveaway, the System Provider notifies both the winning Consumer and the Business who offered the Giveaway of the identification of the Winner.

In the preferred embodiment described herein, each of the links from the Home Page take the user to one of the following subordinate web pages which are described in detail below.
a. Create an Account. The page linked from the “Create an Account” link is the page whereby the Consumer registers with the system by providing any, part, or all of the following information: first name, last name, address, city, state, zip code, phone number, username, password, and email address. The consumer may also be presented with an option to receive special offers, promotions, and information from the System. The Consumer may also be required to agree to Terms and Conditions of Use of the System.
b. Search for Giveaways. The page linked from the “Giveaways” link provides the Consumer with the ability to search for Giveaways within, for example, a specific state by selecting a state (for instance, clicking on the state of Florida). The System then provides a listing of cities within that state. The menu of states may be presented in any form, but may be, for example, a map or a menu. The Consumer may then select a city to view the specific Giveaways in that city. As an example, the city of Fort Lauderdale may be selected, which takes the Consumer to the listing of Businesses offering Giveaways in Fort Lauderdale. The Consumer may then select a Business for which the Consumer desires to register for a Giveaway. Once the Consumer has selected the Business, the Consumer is taken to a page that the Business has built using the features and elements of the System described herein, in which the Consumer may register for the selected Giveaway.
c. Search For Businesses. The page linked from the “Business Directory” link provides the Consumer with the ability to search for Businesses within a specific state by selecting a particular state (for instance, clicking on the state of Florida). The menu of states may be presented in any form, but may be, for example, a map or a menu. The System then provides a listing of cities within that state. The Consumer may then select a city to view the specific Giveaways in that city. As an example, the city of Fort Lauderdale may be selected, which takes the Consumer to the listing of Businesses offering Giveaways in Fort Lauderdale. The Consumer may then select a Business for which the Consumer desires to register for a Giveaway. Once the Consumer has selected the Business, the Consumer is taken to a page that the Business has built using the features and elements of the System described herein, in which the Consumer may register for the selected Giveaway.
d. Create an Account. A Business may follow the “Create an Account” link to register (“Sign Up”) with the System. The Business may input contact information and other useful information about the Business, for example and not by way of limitation first name, last name, username, password, and email address. Other information such as Business address, products, and the like. From this page, a link is provided to allow the Business to begin its “Website” for presentation of the Business to Consumers, and to enter Giveaway listings.
e. Login. A Business may login to this preferred embodiment of the System by providing a username and password. After logging in, the Business is presented with a Business Home Page that is specific to that Business. From this page, the System provides the following functions:
   i. Edit. Following this link allows the Business to edit its information in the system, which may include updating or editing any or all of the following information: first name, last name, Business name, username, password, email address, street address, city, state, zip code, telephone number, business category, and/or business subcategory. Other information may be required by the System at the option of the System Provider.
   ii. Create Business or Company. Following this link allows the Business to create a new website page for one or a plurality of business units within the Business. It may be desirable, for example, that a Business may offer a plurality of products and/or services such that it would be desirable for the Business to build a Web page for each product and/or service. This page of the System features a built in web site building tool for this purpose. The preferred embodiment show also allows the Business to select a “Payment Package” which determines the manner in which the Business will pay the Service Provider for display of the Business' Web Site, coupons (if any), and Giveaways.
   iii. My Businesses, or My Companies. Following this link takes the Business to a web page that allows the Business to add products, goods, or services to their product offerings shown in the System. A listing of the offerings of the Business is shown in this page. This element of the System allows the Business to modify, amend, update, add to, and delete their offerings. Following the “update” link brings the user to the Add/Edit Business feature of the System, which allows the actual editing or addition of offerings of the Business. In the preferred embodiment of the System, the Business has the ability to add Business and/or logo pictures, add a hyperlink to an external web site, add specific text to associate with the hyperlink, add a PDF file (for example, and add a Business may wish to display certain information such as an advertisement, flyer, menu or the like, and create the Web Site that will display to the Consumer when the Consumer views that Business using the System. While the preferred embodiment described herein includes a web site generating tool which is provided to the Business for the purpose of building the Business' Web Site, this is not to be construed as a limitation of the System. A further alternate embodiment of the System may include features for building the Web Site outside the System in which the Web Site may be loaded into the System, or a hyperlink to an external location for the Web Site may be provided to the System by the Business. In the preferred embodiment, the System provides the ability to preview the Web Site prior to adding the web site to the System. Businesses may be charged a fee for each “business”, or offering, they add to the System. Such charges, if any, are determined by the Service Provider. A further optional element that may be included in the System is the ability for the Business to add and/or offer coupons to Consumers. In an alternate embodiment, Following a link such as “Add/Edit Coupons” takes the Business to a web page that provides the functionality for the Business to add a New Coupon. By following a link such as “New Coupon”, the Business is taken to a web page containing the element of a coupon generating tool, which enables the Business to generate a new coupon and upload it to the System for display to Consumers. This feature of the System may further include a link to return to the Business' coupon listing.
   iv. Create New Giveaways. A Business has the ability to add Giveaways to their offerings in the System. A Business may add a description for the Giveaway, select the dates for which the Giveaway will be offered to Consumers, enter a retail value for the Giveaway, and include questions to be asked of a Consumer who is registering for a Giveaway. Such questions may be any question the Business wishes to ask Consumers, such as shopping habits, other habits, patterns of behavior, likes and dislikes, suggestions for product, coupon, service, or Giveaway offers, other any other questions the Business deems desirable. In this manner, a Business may collect voluntarily provided information that may be used by the Business, for example, to establish a database of demographically targeted customers for further advertising campaigns. A calendar tool may also be provided for ease of use by the Business in entering Giveaways.
   v. My Giveaways. A Business may be taken to a web page providing a listing of the Giveaways offered by the Business in the System. This element of the System may provide a Giveaway identification (ID) number, a title for the Giveaway, the name of the offering Business, a category for the Business, the city and state location of the Business, the date of creation of the Giveaway, the date of expiration of the Giveaway, and an element that allows a Business to update the features of each Giveaway. Also provided to a Business may be a calendar depiction or listing of the Giveaways for a Business which may include a hyperlink to a web page indicating the status of the actual Giveaway. The status of a Giveaway may be selected and viewed; for example, an indication as to whether the Giveaway is active or has expired may be shown as well as an indication of whether the Giveaway Winner has been chosen. If the Winner has not been picked the Business may update the Giveaway from this web page.
   vi. Create Banner Ad. This element of the System allows a Business to add a banner advertisement that will display on the Web Pages of the System in a specific geographic area. Following a link such as “Create Banner Add” brings a Business to a web page. The element of the system allows a Business to select for example a state, then cities within the state, in which the Business' banner advertisement is to appear, and allows a Business to select a Payment Package using a pull down menu where payment packages are made available for selection. While specific payment packages are shown in this example, it is understood that the Service Provider can construct any number of Payment Packages, with any terms, that may be desirable.
   vii. My Banner Ads. A Business may follow a link to a web page showing a depiction of the Banner Ads entered into the System for that Business. This element of the Invention may display a listing of the Banner Ads for a Business, showing, for example, a unique advertisement number; a link to the artwork for the advertisement; the geographic areas in which the Banner Ad is to run; the date of creation of the Banner Ad; the expiration date of the Banner Ad; status as to whether the Banner Ad is active; and UPDATE buttons that link to a web page allowing modification of a Banner Ad. From this page the System enables a Business to select a state and city (or cities), Payment Package, select a graphic file for display in the Banner Ad, select a web address for a link to be included in the Banner Ad, and displays the date of creation of the Banner Ad and Expiration date of the Banner Ad. This page also enables the Business to finalize the edits and pay for the selected Banner Ad package.
   viii. Create New Coupons. This element of the System allows a Business to create a coupon, which may be a printable coupon, that will display on a web page of the system, for instance, on the Business page viewable by the Consumers who are registered with the system. Following a link such as “Create Banner Add” brings a Business to a web page.
   ix. My Coupons. A Business may follow a link to a web page showing a depiction of the Coupons entered into the System for that Business as well as information about the coupons such as entry date, expiration date, retail value, and the like.
f. Consumer Login. In the preferred embodiment of the System, a Consumer inputs username and password information and submits this information to login into the System. After logging in, a Consumer (also called a “Member”) may perform the following functions: 1) view a listing of the Giveaways for which they have signed up; 2) change login username; 3) change password; 4) change information about themselves such as address, phone, and email information; 5) view a listing of the Giveaways which they have won; 6) view the Indicating Indicia for any Giveaways they have won: and 7) view other information regarding their participation in the System of the Invention. The System Provided may also provide other functions for the Consumer in any manner the System Provider chooses.
g. About Us. An “About Us” link may be provided that takes the user to a web page that provides information to the user about the benefits of the System, and which may also identify the System Provider.
h. Contact Us. A “Contact Us” link may allow the user to contact the Service Provider via electronic means, which may be email or any other electronic means. The user may input name, email address, phone number, and provide comments to be reviewed by the Service Provider. Also provided may be a button to clear the entry, and a button to submit the information provided by the user to the Service Provider. In this manner communication may be established between the User and the System Provider.
i. Search for Giveaways by Zip Code. A Consumer may search for Giveaways within a specified range of a postal code, for instance a zip code by entering postal code and range information in input spaces provided and clicking a Search button. When a Consumer clicks on the “Search” button, a hyperlink is followed to a web page which displays the search results. The System provides the Consumer with a listing of the current week's giveaways, which may be presented in order by category of good or service which, by way of example and not of limitation, may include categories such as “Automotive”, “Boating and Marine”, “Food and Dining”, and the like. Also presented to the Consumer may be a listing of the following weeks giveaways, which may be ordered by category of good or service which, by way of example and not of limitation, may include categories such as “Automotive”, “Boating and Marine”, “Food and Dining”, and the like. Clicking on a category takes the Consumer to the web page for that category. For example, following a link of “Automotive” may take the Consumer to a web page in which sub-categories such as, by way of example, “Audio/Video & Alarm”, “Dealers”, and the like are presented to the Consumer. If Businesses of the System located in the geographic area had entered Giveaways in this category, they would be presented to the Consumer on this web page.
j. Search for Businesses by Zip Code. A Consumer may search for Businesses within a specified range of a postal code by entering a postal code and range information in the input spaces provided and clicking a search button. When a Consumer clicks on the search button, a hyperlink is followed to a web page that provides the Consumer with a listing of Business, which may be ordered by category of good or service which, by way of example and not of limitation, may include categories such as “Automotive”, “Boating and Marine”, “Food and Dining”, and the like. For example, following a link “Automotive” link may take the Consumer to a web page which presents to the Consumer a listing of sub-categories. By way of example, the sub-categories for the link “Automotive” may be “Audio/Video & Alarm”, “Dealers”, and the like. Continuing with the example, following an “Audio/Video & Alarm” link may take the Consumer via hyperlink to a web page in which businesses are listed for view by the Consumer.

### INDUSTRIAL APPLICABILITY

The present system provides for the advertising of Businesses by the structured offering of Giveaways, which are free gifts, which are offered by Business that is a user of the System to Consumers who are also users of the System. Because Consumers must provide information to the System, in other words, register, Businesses are able to collect and analyze demographic metrics concerning those Consumers who have expressed an interest in that Business' products or services. Such information is valuable for the structuring of product or service offerings, targeted advertising campaigns, analyses of addressable market size and location, and any other analyses for which a Business may make use of the Consumer information.

The System has widespread application across all consumer markets, business types, and product and service offerings.

I claim:

1. A system for advertising utilizing giveaways, comprising a computer program containing instructions for:
Enabling at least one business to register with the system;
Enabling said at least one business to provide giveaway information defining a giveaway, wherein said giveaway is a free gift to be given to a consumer who has registered for receipt of said giveaway;
Enabling a plurality of consumers to view said giveaway information;
Enabling each consumer of said plurality of consumers to register with the system by providing consumer information to the system; and
Choosing at least one winner from the set of consumers who have registered for receipt of said giveaway.

2. The computer program of claim 1, further comprising instructions for:
Providing a portal enabling said at least one business to register with the system by providing business information and wherein access to said business information is protected by a password; and
Providing a portal enabling said each consumer of said plurality of consumers to register with the system wherein said consumer information is protected by a password.

3. The computer program of claim 2, further comprising instructions for enabling a consumer to search the system for giveaways that have been entered into the system by said at least one business within a geographic region.

4. The computer program of claim 3, wherein said at least one winner is selected on a periodic basis.

5. The computer program of claim 4, wherein said geographic region is further defined as selected from the group consisting of a circle of selectable radius centered at a postal code wherein said postal code is selected by said consumer and a geo-political boundary.

6. The computer program of claim 5 wherein said selectable radius is selected from a list of radii provided to the consumer by said computer program.

7. The computer program of claim 2, further comprising instructions for enabling a consumer to search the system businesses that have registered with the system and are located within a geographic region.

8. The computer program of claim 6, wherein said geographic region is further defined as selected from the group consisting of a circle of selectable radius centered at a postal code wherein said postal code is selected by said consumer and a geo-political boundary.

9. The computer program of claim 5 wherein said selectable radius is selected from a list of radii provided to the consumer by said computer program.

10. The computer program of claim 4, further comprising instructions for enabling a registered consumer to view the giveaways for which said registered consumer has registered.

11. The computer program of claim 4, further comprising instructions for providing consumer information to businesses that have registered with the system.

12. The computer program of claim 4, further comprising instructions for:
Enabling said at least one business to create a home page viewable by a consumer;
Enabling said at least one business to enter into the system in a plurality of companies wherein each company may enter a giveaway into the system;
Enabling said at least one business to enter into the system at least one coupon, wherein said coupon may be downloaded by said at least one registered consumer; and
Enabling said at least one business to view of list of giveaways entered into the system by said at least one business.

13. A method for advertising utilizing giveaways, comprising the steps of:
Enabling at least one business to register with the system;
Enabling said at least one business to provide giveaway information defining a giveaway, wherein said giveaway is a free gift to be given to a consumer who has registered for receipt of said giveaway;
Enabling a plurality of consumers to view said giveaway information;
Enabling each consumer of said plurality of consumers to register to win said giveaway by providing consumer information to the system; and
Choosing at least one winner from the set of consumers who have registered for receipt of said giveaway.

14. The method of claim 13, wherein said at least one winner is selected on a periodic basis.

15. The method of claim 14, further comprised of the step of enabling a consumer to search the system for giveaways that have been entered into the system by said at least one business within a geographic region.

16. The method claim 15, wherein said geographic region is further defined as a radius from postal code, or a geo-political boundary.

17. The method of claim 14, further comprised of the step of enabling a consumer to search the system for businesses that have been registered with the system and that are located within a geographic region.

18. The method claim 17, wherein said geographic region is further defined as a radius from postal code, or a geo-political boundary.

19. The method of claim 14, further comprising the steps of:
Enabling said at least one business to present marketing information to consumers who are registered with the system; and
Enabling said at least one business to provide coupons to consumers who are registered with the system.

20. The method of claim 14, further comprising the steps of:
Collecting said consumer information;
Organizing said consumer information; and
Providing said consumer information to said at least one business.
